(19) United States
(12) Patent Application Publication
(10) Pub. No.: US 2026/0221992 A1
(43) Pub. Date: Jul. 30, 2026

(54) CAPACITIVE COMMUNICATION SYSTEM AND CONFIGURATION

(71) Applicant: Infineon Technologies Austria AG, Villach (AT)

(72) Inventors: Varun AGRAWAL, Villach (AU); Thomas FERIANZ, Bodensdorf (AT)

(21) Appl. No.: 19/037,624

(22) Filed: Jan. 27, 2025

(51) Int. Cl. H04B 1/04

(52) U.S. Cl. CPC H04B 1/04

(57) ABSTRACT

A transmitter circuit disposed at a first terminal of a capacitor coupled communication link receives a first signal. Based on the first signal, the transmitter circuit produces a second signal (transmitter drive signal), which may be a first differential signal including a first sub-signal and a second sub-signal. The transmitter circuit generates the first sub-signal in accordance with a first duty cycle; the transmitter circuit generates the second sub-signal in accordance with a second duty cycle. The second duty cycle is different than the first duty cycle. The transmitter circuit further transmits the first differential signal including the first sub-signal and the second sub-signal over a capacitive coupled communication link to a receiver circuit at a second terminal of the capacitor coupled communication link. The implementation of the transmitter drive signal as discussed herein results in a stronger signal received at a receiver circuit with respect to a noise floor.

### BACKGROUND

One of the main challenges in digital isolator architectures is the capability to withstand fast common mode surges across a respective galvanic barrier, a figure of merit known as Common Mode Transient Immunity (CMTI). Capacitive coupled digital isolators offer a better area usage while presenting a worse CMTI performance when compared to their inductively coupled counterpart. For this reason, improving the CMTI in capacitive coupled communication architectures is desirable.

Most commercial solutions of such architectures employ the use of blanking times to mask disturbances created by CMT events. This blanking time is added to the whole chain propagation delay of the system and is effective as long as the event duration is shorter than the blanking time.

Other known solutions involve the use of passive High Pass filters to eliminate disturbances below the carrier frequency on OOK modulations but are sensitive to high-frequency interferences which could be mixed down into the signal frequency when trying to detect the signal envelope. Moreover, it is noted that a passive filter attenuates the signal which makes its demodulation even harder, so to compensate for this attenuation a pre-amplifier is required as the first block in the receiver chain. Any block placed directly connected to the isolation capacitor requires extra consideration with regards to CMT events and the associated displacement current it generates, which increases the complexity of its design.

It is further noted that conventional techniques of implementing capacitive coupled communication links includes receiving signal and then transmitting a differential signal over multiple different paths of a respective communication link. In general, the differential signal transmitted over the conventional capacitive coupled communication link includes a first signal and a second signal, where the second signal is an inversion of the first signal.

### BRIEF DESCRIPTION

This disclosure includes the observation that a so-called signal-to-noise ratio is an important parameter of a communication system, where the signal-to-noise ratio typically defines the performance of the system. Any improvement in increasing a magnitude of the signal-to-noise ratio can help to improve the system performance and the system immunity with regards to internal or external noise.

As previously discussed, it is further noted that a capacitive coupled digital isolator uses differential channels to eliminate the effect of common mode transient noise (CMTI) and out of phase signal to transmit carrier over the differential isolation channel which goes through high attenuation due to big parasitic capacitance present between lower isolation capacitor plate and the substrate. This makes it difficult to detect the weak signal received at the receiver, wherein the weak received signal is also prone to CMTI noise.

To address the deficiencies associated with conventional techniques of implementing a capacitive coupled communication link, this disclosure implements novel phase shifting and duty cycle control associated with one or more respective carrier signals transmitted from a transmitter side of the capacitive coupled communication link. As further discussed herein, the novel generation of signals has the effect of shifting the fundamental tone of the transmitted carrier to twice the frequency, which increases the overall amount of power associated with a signal received at the receiver side.

More specifically, the disclosure as discussed herein includes an apparatus including a transmitter circuit. The transmitter circuit receives a first signal including data for transmission to a corresponding receiver. Based on the first signal, the transmitter circuit produces a second signal. In one example, the second signal is a first differential signal including a first sub-signal and a second sub-signal. The transmitter circuit generates the first sub-signal in accordance with a first duty cycle; the transmitter circuit generates the second sub-signal in accordance with a second duty cycle. The second duty cycle is different than the first duty cycle. The transmitter circuit further transmits the first differential signal including the first sub-signal and the second sub-signal over a capacitive coupled communication link to a receiver circuit.

The apparatus may further include a receiver circuit operative to receive the transmitted first differential signal (such as received as a second differential signal) from the capacitive communication link at a second frequency, where the second frequency is twice a magnitude of the first frequency at which both the first sub-signal and the second sub-signal are transmitted.

In a further example, the transmitter circuit can be configured to produce the first sub-signal and the second sub-signal such that the second sub-signal is phase shifted or phase controlled with respect to the first sub-signal. Accordingly, in one example, an inverted wave shape of the second sub-signal is substantially similar to a wave shape of the first sub-signal.

In yet further examples, the transmitter circuit is operative to transmit both the first sub-signal and the second sub-signal at a first frequency to a receiver. As previously discussed, the first sub-signal and the second sub-signal may be phase shifted with respect to each other. A first noise floor at the receiver may be greater than a second noise floor at the receiver at a second frequency. The phase shift between the first sub and the second sub-signal results in the transmitted differential signal being effectively transmitted at a higher frequency, where the received signal at receiver has a lower noise floor.

In still further examples as discussed, the capacitive coupled communication link includes a first capacitive coupled path and a second capacitive coupled path. As previously discussed, the capacitive coupling provides noise immunity between the transmitter and receiver. The transmitter circuit can be configured to transmit the first sub-signal over the first capacitive coupled path as well as transmit the second sub-signal over the second capacitive coupled path.

As previously discussed, the second duty cycle associated with the second sub-signal may be different than the first duty cycle associated with the first sub-signal. In one example, the first duty cycle of the first sub-signal may be between 15 percent and 35 percent; the second duty cycle of the second sub-signal may be between 65 percent and 85 percent.

In a further example as discussed herein, the transmitter circuit can be configured to transmit the second sub-signal as being phase shifted with respect to the first sub-signal such that, for each respective control cycle of multiple control cycles of transmitting the differential signal, a respective rising edge and a respective subsequent falling edge of the first sub-signal falls in between a respective rising edge and a respective falling edge of the second sub-signal.

In yet another example, the transmitter is configured to transmit both the first sub-signal and the second sub-signal at a first frequency (same frequency). The receiver circuit as discussed herein can be configured to include a bandpass filter circuit having a center frequency set to twice the magnitude of the first frequency.

Further examples as discussed herein include one or more methods. In one example, a method as discussed herein includes: receiving a first signal; producing a second signal based on the first signal, the second signal being a first differential signal including a first sub-signal and a second sub-signal, the first sub-signal having a first duty cycle, the second sub-signal having a second duty cycle; and transmitting the first sub-signal and the second sub-signal over a differential capacitive coupled communication link to a receiver circuit, the first sub-signal having a different duty cycle than the second sub-signal.

Techniques as discussed herein are useful in order to ensure that a respective receiver circuit is able to reproduce a better rendition of the first signal based on the reception of the transmitted differential signal. More specifically, phase shifting and duty control of producing the carrier signal at the transmitter side shifts the fundamental tone (frequency) to twice frequency which increase the signal power at the receiver side.

These and other more specific concepts are discussed in more detail below.

As further discussed herein, techniques herein are well suited for use in the field of communications. However, it should be noted that this disclosure is not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be implemented and viewed in many different ways.

Also, note that this preliminary discussion herein (BRIEF DESCRIPTION) purposefully does not specify every implementation and/or incrementally novel aspect of the present disclosure or claimed invention(s). Instead, this brief description only presents general implementations and corresponding points of novelty over conventional techniques. For additional details and/or possible perspectives (permutations) of the invention(s), the reader is directed to the Detailed Description section (which is a summary of possible implementation and operations) and corresponding figures of the present disclosure as further discussed below.

### BRIEF DESCRIPTION OF THE DRAWINGS

FIG. 1 is an example general diagram of a communication system and corresponding transmitter-receiver communication channel pairs operating in first data flow mode as disclosed herein.

FIG. 2 is an example general diagram of a communication system and corresponding transmitter-receiver as discussed herein.

FIG. 3 is an example diagram illustrating driver circuitry (such as a transmitter) in a communication system as discussed herein.

FIG. 4 is an example diagram illustrating details of a receiver circuit as disclosed herein.

FIG. 5 is an example diagram illustrating occurrence of a transient condition and effect on mismatched capacitive channels as well as transmission of a differential signal INP-INN over a capacitive coupled communication link as disclosed herein.

FIG. 6 is an example timing diagram of signals as discussed herein.

FIG. 7 is an example diagram illustrating a demodulator disposed in a second communication circuit as disclosed herein.

FIG. 8 is an example diagram illustrating a demodulator and comparator disposed in a second communication circuit as disclosed herein.

FIG. 9A is an example timing diagram illustrating implementation of a first differential transmitter signal as discussed herein.

FIG. 9B is an example timing diagram illustrating a received differential signal associated with a transmitted first differential transmitter signal as discussed herein.

FIG. 9C is an example diagram illustrating the spectrum of different frequencies and corresponding magnitudes of the different frequencies associated with the received differential signal in FIG. 10B.

FIG. 10A is an example timing diagram illustrating implementation of a novel differential transmitter signal as discussed herein.

FIG. 10B is an example timing diagram illustrating a received differential signal associated with the transmitted first differential transmitter signal as discussed herein.

FIG. 10C is an example diagram illustrating a spectrum of different frequencies and corresponding magnitudes associated with the received differential signal in FIG. 11B.

FIG. 11 is an example diagram illustrating a spectrum of different frequencies and corresponding magnitudes associated with different instances of received differential signals with respect to a noise floor as discussed herein.

FIG. 12 is an example diagram illustrating of a method as discussed herein.

The foregoing and other objects, features, and advantages of the invention will be apparent from the following more particular description of preferred implementations herein, as illustrated in the accompanying drawings in which like reference characters refer to the same parts throughout the different views. The drawings are not necessarily to scale, with emphasis instead being placed upon illustrating the implementations, operations, principles, concepts, etc.

### DETAILED DESCRIPTION

In general, as discussed herein, a transmitter circuit disposed at a first terminal of a capacitive-coupled communication link receives a first signal. Based on the first signal and corresponding encoded digital data, the transmitter circuit produces a second signal (transmitter drive signal), which may be a first differential signal including a first sub-signal and a second sub-signal. The transmitter circuit generates the first sub-signal in accordance with a first duty cycle; the transmitter circuit generates the second sub-signal in accordance with a second duty cycle. The second duty cycle may be different than the first duty cycle. The transmitter circuit further transmits the first differential signal including the first sub-signal and the second sub-signal over a respective differential circuit path of the capacitive coupled communication link to a receiver circuit at a second terminal of the capacitor coupled communication link. The receiver circuit at the second terminal converts the received differential signal into a reproduction of the first signal. The implementation of the transmitter drive signal (such as duty cycle adjusted and/or phase adjusted) as discussed herein results in a stronger signal (higher power level signal) received at a receiver circuit with respect to a noise floor than conventional techniques of transmitting over a respective capacitive coupled communication link.

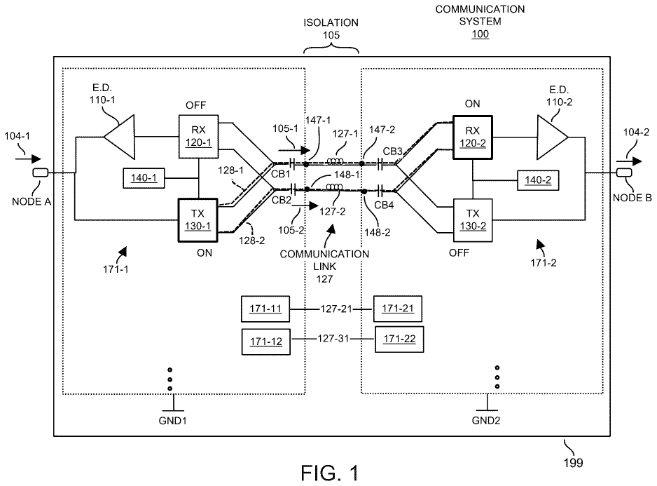

Now, more specifically, FIG. 1 is an example general diagram of a communication system and corresponding transmitter-receiver communication channel pairs operating in first data flow mode where a transmitter circuit transmits to a receiver circuit as discussed herein.

As shown, the communication system 100 includes communication circuit 171-1 (transceiver pair) and communication circuit 171-2 (transceiver pair) disposed on the substrate 199. Note that the implementation of substrate 199 is not necessary as the communication circuit 171-1 and the communication circuit 171-2 can be disparately located with respect to each other without being affixed to a common substrate 199.

Thus, the first communication circuit 171-1 and the second communication circuit 171-2 are part of a respective communication system 100.

Note that the first communication circuit 171-1 and the second communication circuit 171-2 may or may not be affixed to a common substrate 199.

Each of the communication circuit 171-1 and the communication circuit 171-2 include multiple components supporting conveyance of data between each other. For example, the communication circuit 171-1 includes controller 140-1. The controller 140-1 controls whether the communication circuit 171-1 is set to a transmitter mode of communicating data signals 105 (such as a differential signal including signal 105-1 and signal 105-2) over the communication path 128 (which includes the differential communication path of communication path 128-1 and communication path 128-2) to the communication circuit 171-2 or whether the communication circuit 171-1 is set to a receiver mode of receiving data signals from the communication circuit 171-2.

Similarly, the communication circuit 171-2 includes controller 140-2. The controller 140-2 controls whether the communication circuit 171-2 is set to a transmitter mode of communicating data signals from the transmitter 130-2 over the capacitive coupled communication path to the communication circuit 171-1 or whether the circuit 171-2 is set to a receiver mode of receiving data (such as via a received differential signal) from the communication circuit 171-1.

As further shown in FIG. 1, the controller 140-1 controls the transmitter 130-1 and corresponding circuitry to be in an ON-state while controller 140-1 controls the receiver 120-1 and corresponding circuitry to be in an OFF-state. This causes the communication circuit 171-1 to be set to a transmitter mode of communicating data over the communication link (127, 128) to the communication circuit 171-2 as shown in FIG. 1. Note that the transmitter 130-1 can be configured to include any suitable hardware (clocks, logic, flip-flops, circuitry, etc.) or executed software to produce the respective signals 105-1 and 105-2 transmitted over respective communication paths 128-1 and 128-2.

Further in FIG. 1, the controller 140-2 controls the transmitter 130-2 and corresponding circuitry to be in an OFF-state while the controller 140-1 controls the receiver 120-2 and corresponding circuitry to be in an ON-state such that the communication circuit 171-2 in corresponding receiver 120-2 receives data over the differential communication link 127 (such as including communication path 127-1 and 127-2) as transmitted by the transmitter 130-1.

The pair of links 127 (including link 127-1 and link 127-2) provide connectivity associated with the capacitive communication paths 128 (capacitive communication path 128-1 and capacitive communication path 128-2) extending between the transmitter 130-1 and the receiver 120-2. The capacitive communication path 128-1 of the communication path 128 includes a series connectivity of capacitor CB1 (such as a so-called blocking capacitor), link 127-1, and capacitor CB3 (such as a so-called blocking capacitor) between the transmitter 130-1 and the receiver 120-2.

The capacitive communication path 128-2 of the communication path 128 includes a series connectivity of capacitor CB2 (such as a blocking capacitor), link 127-2, and capacitor CB4 (such as a blocking capacitor) between the transmitter 130-1 and the receiver 120-2.

Note that the communication path such as link 127-1 and the link 127-2 are susceptible to mismatch, resulting in RLC (resistance, inductors, and/or capacitance) mismatch between the first capacitive communication path 128-1 and the second capacitive communication path 128-2. As shown, the first capacitive communication path 128-1 extends between the transmitter 130-1 and the receiver 120-2 during a respective mode in which the transmitter 130-1 and the receiver 120-2 are both set to an ON-state.

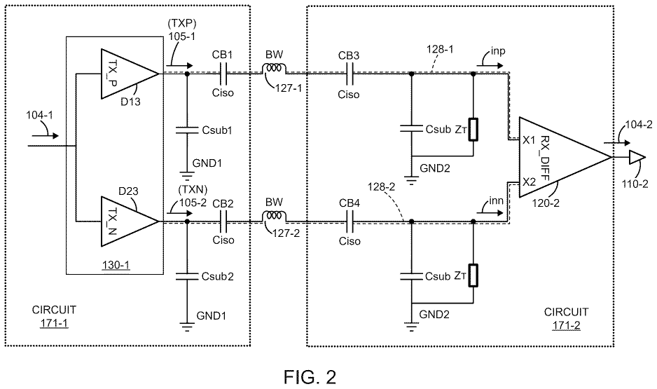

FIG. 2 is an example general diagram of a communication system and corresponding transmitter-receiver as discussed herein.

In this example, the transmitter 130-1 of the communication circuit 171-1 is implemented as a differential driver including the driver D13 to transmit the signal 105-1 (a.k.a., TXP) over the communication path 128-1 and the driver D23 to transmit the signal 105-2 (a.k.a., TXN) over the communication path 128-2.

Both the driver D13 and the driver D23 receive the signal 104-1 for transmission of respective data in the differential signal 105 (including signal 105-1 and signal 105-2) to the communication circuit 171-2.

During a first condition in which the input signal 104-1 is a logic low, the driver D13 outputs a respective signal 105-1 (a static ground voltage GND1) over the communication path 128-1 while the driver D23 also outputs a respective signal 105-2 (a static ground voltage GND1) over the communication path 128-2.

During a second condition in which the input signal 104-1 is a logic high, the driver D13 outputs a respective signal 105-1 (a first voltage varying signal) over the communication path 128-1 while the driver D23 outputs a respective signal 105-2 (a second voltage varying signal) over the communication path 128-2.

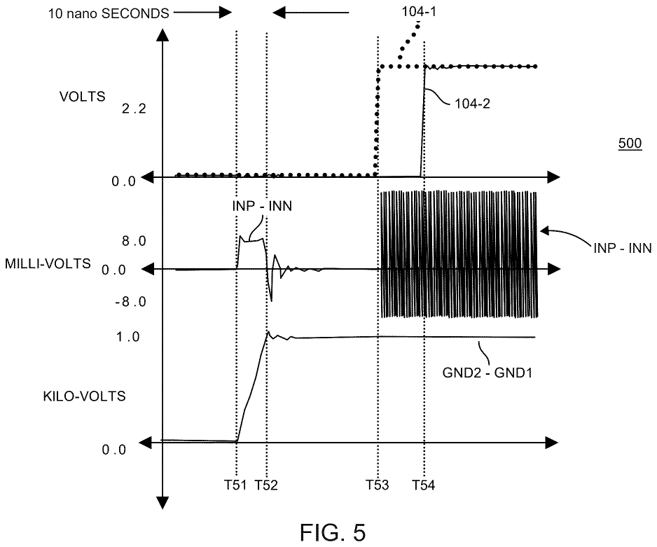

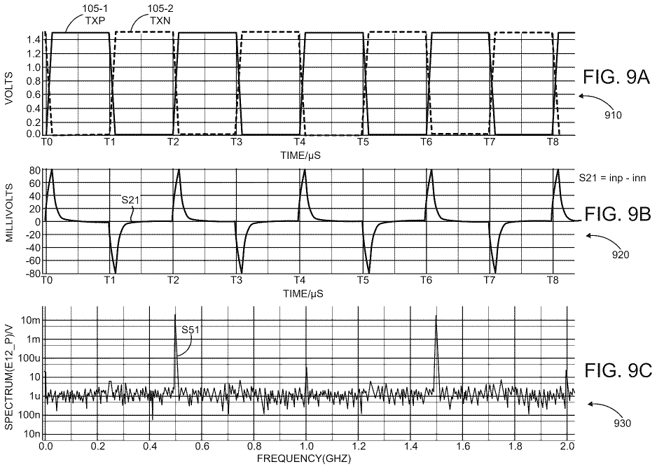

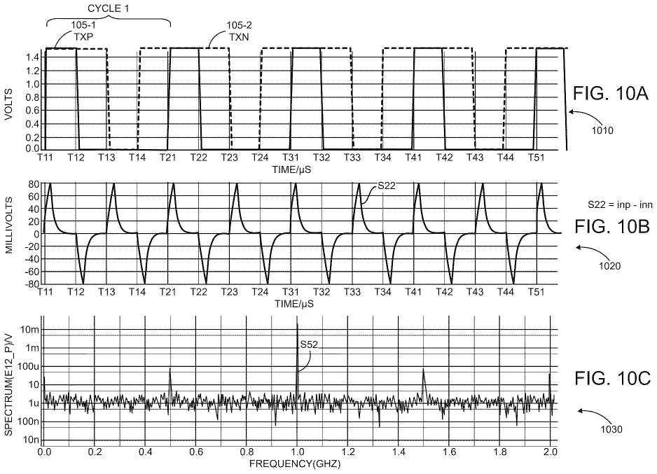

One example of the signals 105-1 and 105-2 is illustrated in graph 500 of FIG. 5. Another example of the signals 105-1 and 105-2 is shown in FIG. 9A. Yet another example of the signals 105-1 and 105-2 is shown in FIG. 10A.

Referring again to FIG. 2, it is noted that respective blocking capacitor CB1 and blocking capacitor CB3 are serially disposed in the respective communication path 128-1.

As their names suggest, the blocking capacitors disposed in the communication path 128-1 block DC components associated with the transmitted signal 105-1 but allow respective AC components of the transmitted signal 105-1 to be received as signal INP at the first terminal X1 of the differential receiver 120-2.

Further, as their names suggest, the blocking capacitors disposed in the communication path 128-2 block DC components associated with the transmitted signal 105-2 but allow respective AC components of the transmitted signal 105-2 to be received as signal INN at the second terminal X2 of the differential receiver 120-2.

As further discussed herein, based on the detected difference between the signal INP and the signal INN, the receiver 120-2 produces the signal 104-2 such as a reproduction of the signal 104-1.

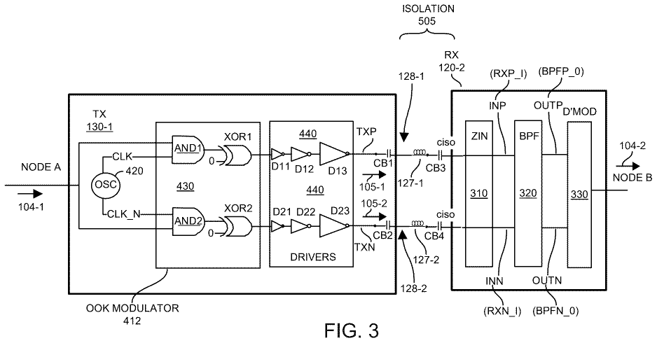

FIG. 3 is an example diagram illustrating additional details of a transmitter and receiver of a respective communication system as discussed herein.

As shown in this example, implementation of the transmitter 130-1 (and related components) may include oscillator 420, modulator 430 (including logic AND1, logic AND2, logic XOR1, and logic XOR2), and drivers 440. Implementation of the receiver 120-2 includes the impedance adjustment circuit 310, bandpass filter 320, and the demodulator 330.

The transmitter 130-1 receives signal 104-1 in a manner as previously discussed. Signal 104-1 is inputted to the inputs of the logic AND1 and logic AND2. Signal CLK generated by the oscillator 420 is inputted to the logic AND1; signal CLK_N (inverse state of CLK) generated by the oscillator 420 is inputted to the logic AND2.

The output of logic AND1 and the setting zero (0) drives the respective first input and the second input of logic XOR1. As further shown, the output of the logic XOR1 drives the series sequence of drivers D11, D12, D13. Driver D13 outputs the corresponding signal 105-1 (or signal TXP) to the communication path 128-1 including the capacitor CB1.

The output of logic AND2 and the setting zero (0) drive the respective first input and the second input of logic XOR2. As further shown, the output of the logic XOR2 drives the series sequence of drivers D21, D22, D23. Driver D23 outputs the corresponding signal 105-2 (or TXN) to the communication path 128-2 including the capacitor CB2.

In a non-test mode as shown, the signal TXP (105-1) and signal TXN (105-2) such as shown in FIG. 9A are opposite states to form a differential signal transmitted over the communication path 128. That is, when the input signal 104-1 is a logic high, signal TXP and TXN are transmitted 180° out of phase with respect to each other at the frequency defined by the OSC (402). Conversely, when the input signal 104-1 is a logic low, both signal TXP and signal TXN are a logic low.

Thus, according to one configuration, the On-OFF Keying modulator 430 is performed by a simple logic AND combination of the input signal 104-1, received from the input pin (node A), with the oscillator 420 output signal defined as CLK and CLK_N. As previously discussed, the CLK_N signal is 180 degrees out of phase with respect to CLK signal.

As further shown, the receiver 120-2 can be configured to include impedance adjustment circuit 310, bandpass filter 320, and modulator 330.

As discussed herein, common mode transient (CMT) surge is one of the main challenges in digital galvanic isolated systems such as communication system 100. The key element of the CMT surge that impacts the correct functionality of a differential communication system 100 is the conversion of the common-mode into differential-mode due to unbalanced (unmatched) elements in each of the capacitive communication channels 128.

As further discussed herein, the transmitter 130-1 can be modified to produce the transmitter signals 105-1 and 105-2 as shown in FIG. 10A.

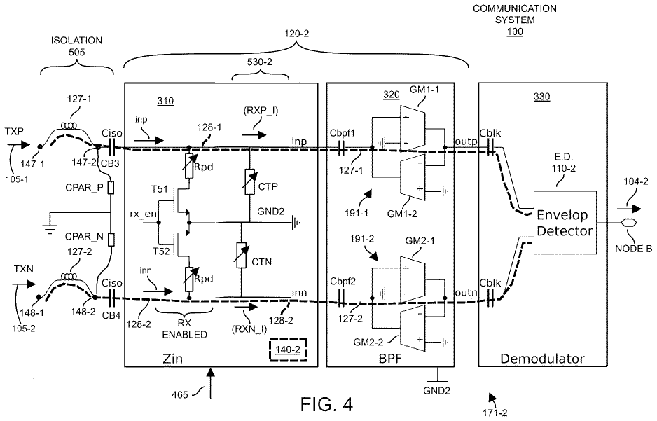

In the receiver 120-2, the impedance adjustment circuit 310 (such as input matching impedance block Zin) shapes the received signal accordingly to the values of all RLC elements present in the network formed by the isolation capacitors (such as Ciso, see also FIG. 4 for details), wirebonds, parasitic capacitors (such as Cpar_p & Cpar_n, see FIG. 5 for details), trimming capacitors (such as ctp & ctn, see FIG. 4 for details) and pull-down resistors (such as Rpd, see FIG. 4 for details). Assuming that all elements of the above-mentioned RLC network in each different communication path are perfectly or nearly matched, the transmission of a common-mode signal, txp_o in phase with txn_o during a test mode, would produce no differential signal (OUTP−OUTN) at the receiver side. In such an instance, when the impedance adjustment circuit 310 is properly calibrated, the system 100 is intrinsically robust against any CMT surges and this is exactly the target performance of the system in normal operation mode (non-test mode).

To avoid errors associated with conversion of the receives difference signal INP-INN (or output signals OUTP and OUTN from the bandpass filter 320) into the output signal 104-1, the demodulator 330 as further discussed herein can be configured with a defined threshold level of a respective comparator to determine a respective condition in which the transmitted signal 105-1 corresponds to a logic one at the input 104-1.

FIG. 4 is an example diagram illustrating details of a receiver circuit as disclosed herein.

In this example, the controller 140-2 and corresponding circuitry including transistor T51 and transistor T52 controls the operation of the receiver 120-2 in the receiver mode. For example, the controller 140-2 sets signal rx_en to a logic high, connecting the resistor Rpd1 between the circuit path 128-1 and ground reference GND2. Setting of signal rx_en to a logic high also causes connection of the resistor Rpd2 between the circuit path 128-2 and ground reference GND2.

As shown, the active inductor 191-1 in communication path 128-1 may be implemented in the band-pass filter 320 via a combination of transconductance amplifier GM1-1 and transconductance amplifier GM1-2 as well as capacitor Cbpf1. Capacitor Cbpf1 is associated with band-pass filter 320. As its name suggests, the capacitor Cblk in the demodulator 330 is a DC blocking capacitor. The inductance of the active inductor 191-1 and the bandpass capacitor Cbpf1 controls a setting of the frequencies associated with the bandpass filter response 320 and, more specifically, which window of frequencies associated with the received signal INP (or portion of transmitted signal 105-1) are passed along communication path 128-1 as signal OUTP to the envelope detector 110-2.

Similarly, in this example, the active inductor 191-2 in communication path 128-2 is implemented in the band-pass filter 320 via a combination of transconductance amplifier GM2-1 and transconductance amplifier GM2-2 as well as capacitor Cbpf2. Capacitor Cbpf2 is associated with band-pass filter 320. As its name suggests, the capacitor Cblk in the demodulator 330 is a DC blocking capacitor. The inductance of the active inductor 191-2 and the bandpass capacitor Cbpf2 control a setting of the frequencies associated with the bandpass filter response 320 and, more specifically, which window of frequencies associated with the received signal INN (or portion of the signal TXN) are passed along communication path 128-2 as signal OUTN to the envelope detector 110-2.

Thus, the bandpass filter 320 implemented by the active inductor 191-1 receives the input signal INP and outputs the corresponding output signal OUTP supplied to the demodulator 330 and corresponding envelope detector 110-2. The bandpass filter 320 implemented by the active inductor 191-2 receives the input signal INN and outputs the corresponding output signal OUTN supplied to the demodulator 330 and corresponding envelope detector 110-2.

As further discussed herein, the envelope detector 110-2 uses the input signals OUTP and OUTN (derived from the respective signals INP and INN) as a basis in which to detect when a logic one is being conveyed from the input node A to the output node B of the communication system 100.

FIG. 5 is an example diagram illustrating occurrence of a transient condition and effect on mismatched capacitive channels as discussed herein.

Graph 500 illustrates operation of the communication system 100 in a non-test mode to illustrate undesirable signal disturbance when the first communication path 128-1 is not matched to the second communication path 128-2.

As shown in graph 500, the difference voltage between the ground reference GND1 and ground reference GND2 may vary substantially over time. For example, in graph 500, the difference between ground reference GND2 and ground reference GND1 rapidly changes during a respective transient condition between time T51 and time T52. In such an instance, between time T51 and time T52, the voltage difference between signal INN and signal INP (signal INN-INP) experiences a disturbance as well.

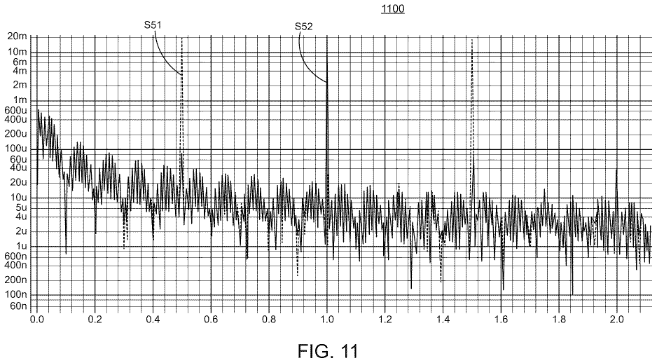

As further shown in graph 500, the signal 104-1 is a logic low up until time T53. Thus, up until time T53, the output signal 104-2 is a logic low as well despite the minor disturbance at or around time T51 to T52. At time T53, the driver circuitry D13 and driver circuitry D23 transmits respective signals as shown in graph 1010 in FIG. 10A or graph 1110 in FIG. 11A, resulting in the signal INP-INN.

As further discussed herein, the novel implementation of the drive signals 105-1 and 105-2 as shown in graph 1010 (as opposed to the drive signals shown in graph 910) provide a more robust conveyance of respective data between the transmitter 130-1 and the receiver 120-2 and corresponding envelope detector.

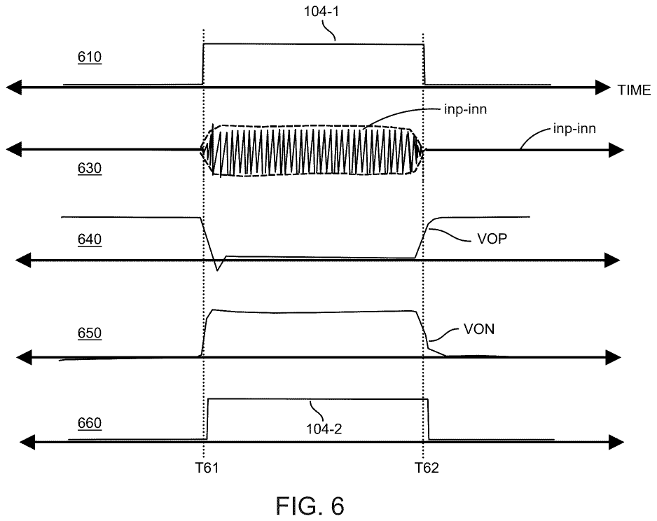

FIG. 6 is an example timing diagram of signals as discussed herein.

Assume that the controllers (140-1, 140-2), operate the communication circuit 171-1 in a transmitter mode and communication circuit 171-2 in a receiver mode. As shown, FIG. 6 illustrates operation of the circuit to convey data from the input node A to the output node B of the capacitive coupled communication system.

For example, graph 610 illustrates timing of input signal 104-1, which is logic high between time T61 and T62 and otherwise logic low.

Graph 630 illustrates timing associated with the detected difference between signal INP and signal INN and corresponding resonant operation at a resonant frequency between time T61 and T62 when signal 104-1 is a logic high. Note again that the resonant frequency associated with the transmitter 130-1 and corresponding transmitted signal 105-2 is substantially greater than the frequency of signal 104-1.

Graph 640 illustrates the magnitude of voltage VOP over time. Graph 650 illustrates the magnitude of voltage VON over time.

Graph 660 illustrates the generation and output of the corresponding signal 104-2 from the communication circuit 171-2. As shown, the output signal 104-2 is slightly delayed with respect to the input signal 104-1.

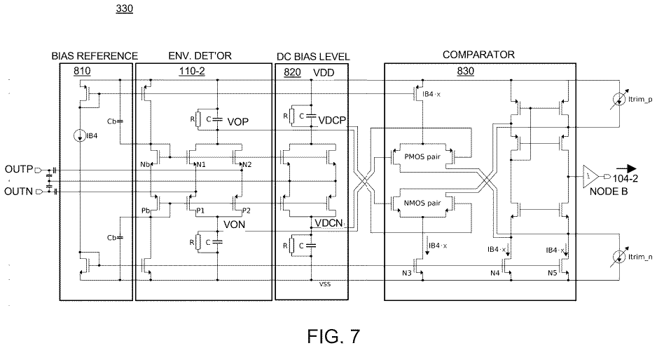

FIG. 7 is an example diagram illustrating a demodulator disposed in a second communication circuit as disclosed herein.

As previously discussed in FIG. 4, the demodulator 330 receives the signal OUTP conveyed over communication path 128-1 and signal OUTN conveyed over communication path 128-2. In this example of FIG. 7, the demodulator 330 includes bias reference circuit 810, envelope detector 110-2, DC bias level circuit 820, and comparator 830.

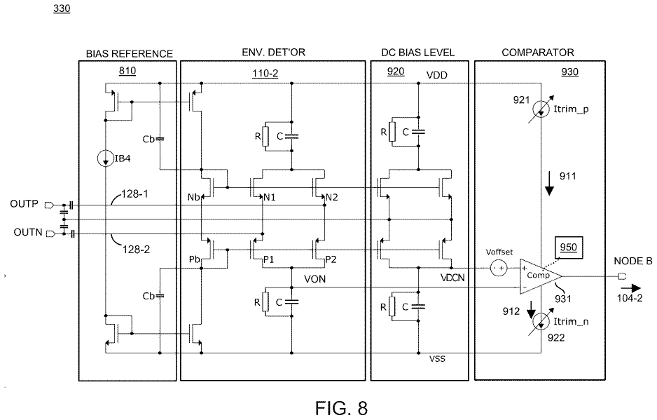

FIG. 8 is an example diagram illustrating a demodulator and comparator disposed in a second communication circuit as disclosed herein.

In this example, the demodulator 330 includes bias reference circuit 810, envelope detector 110-2, DC bias level circuit 920, and comparator 930 (such as equivalent of comparator 830). The comparator 930 is configured to monitor the differential voltage VON−VDCN, which is generated based on the signal OUTP conveyed over communication path 128-1 and signal OUTN conveyed over communication path 128-2.

As previously discussed, a magnitude of the signal OUTP depends upon the amount of the signal INP transmitted through the bandpass filter implemented via the active inductor 191-1. A magnitude of the signal OUTN depends upon the amount of the signal INN transmitted through the bandpass filter implemented via the active inductor 191-2.

Note again that the bandpass filter 320 can be implemented in any suitable manner such as via a passive filter or an active filter.

Note further that the settings of the threshold level 950 applied to the comparator 931 may be based upon a magnitude of the trim current 911 provided by the current source 921 and the magnitude of the trim current 912 provided by the current source 922 to the comparator 931. During the non-test mode, the threshold level 950 may be relatively high with respect to a noise floor as discussed herein to provide noise immunity.

FIG. 9A is an example timing diagram illustrating implementation of a first instance of a differential transmitter signal as discussed herein.

In this example, the driver D13 associated with the transmitter 130-1 generates the signal 105-1 (TXP) and the signal 105-2 (TXN) in a manner as shown in graph 910.

For example, in a first cycle between time T0 and time T2, the driver D13 outputs the signal 105-1 as being a logic high between time T0 and time T1; the driver D13 outputs the signal 105-1 as a logic low between time T1 and time T2.

Further, in the first cycle between time T0 and time T2, the driver D23 outputs the signal 105-2 as being a logic low between time T0 and time T1; the driver D23 outputs the signal 105-1 as a logic high between time T1 and time T2.

In such an instance, for the first cycle in graph 910, the portion of the signal 105-1 transmitted over the communication path 128-1 and received at the X1 node of the receiver 120-2 is signal INP; the portion of the signal 105-2 transmitted over the communication path 120-2 and received at the X2 node of the receiver 120-2 is signal INN. Thus, as shown in graph 920 of FIG. 9B, the input of the receiver 104-2 such as between the node X1 and node X2 of the receiver 120-2 receives a differential signal S21 equal to INP−INN such as including a positive voltage spike and corresponding settling to 0 millivolts just after time T0 and a negative voltage spike and corresponding settling to 0 millivolts just after time T1.

In a second cycle between time T2 and time T4 shown in graph 910 of FIG. 9A, the driver D13 outputs the signal 105-1 as being a logic high between time T2 and time T3; the driver D13 outputs the signal 105-1 as a logic low between time T3 and time T4.

Further, in the second cycle between time T2 and time T4, the driver D23 outputs the signal 105-2 as being a logic low between time T2 and time T3; the driver D23 outputs the signal 105-2 as a logic high between time T3 and time T4.

In such an instance, for the second cycle in graph 910, the portion of the signal 105-1 transmitted over the communication path 128-1 and received at the X1 node of the receiver 120-2 is signal INP; the portion of the signal 105-2 transmitted over the communication path 120-2 and received at the X2 node of the receiver 120-2 is signal INN. Thus, as shown in graph 920 in FIG. 9B, the input of the receiver 104-2 such as between the node X1 and node X2 receives a differential signal S21 equal to INP−INN such as including a positive voltage spike just after time T2 and a negative voltage spike just after time T3.

In this manner, for each of multiple control cycles, the transmitter 130-1 and corresponding one or more drivers can be configured to generate inverted signals (105-1 and 105-2) with respect to each other of 50 percent duty cycle (and out of phase with respect to each other by 180 degrees) to communicate a logic one state of signal 104-1 over the communication path 128 to the receiver 120-2.

FIG. 9C is an example graph illustrating the spectrum of different frequencies and corresponding magnitudes associated with the received differential signal INP-INN shown in graph 920 in FIG. 9B.

More specifically, assume that the frequency of the driver 130-1 transmitting the signals 105-1 and 105-2 is 500 megahertz. As shown in graph 930 and corresponding spectral signal S51 (indicating signal strengths at different frequencies) associated with the signal S21, a magnitude of the received power associated with the signal S2 (INP−INN) is strongest at the corresponding transmitter frequency (carrier frequency) 500 megahertz because the respective bandpass filters disposed in the communication path 128 are set to a 500 megahertz center frequency.

It is further noted that the received signal S2 may also include harmonics at carrier frequencies 1 gigahertz, 1.5 gigahertz, etc. However, the main signal S21 (INP-INN) is received that the 500 megahertz.

FIG. 10A is an example timing diagram illustrating implementation of a second instance of a differential transmitter signal as discussed herein.

In this example, in contrast to prior implementations, the driver D13 and driver D23 associated with the transmitter 130-1 are configured to generate the signal 105-1 (TXP) and the signal 105-2 (TXN) in a manner as shown in graph 1010.

More specifically, in a first cycle between time T11 and time T21, the driver D13 associated with the transmitter 130-1 outputs the signal 105-1 as being a logic high between time T11 and time T12; the driver D13 associated with the transmitter 130-1 outputs the signal 105-1 as a logic low between time T12 and time T21. Accordingly, the signal 105-1 is set to a 25 percent duty cycle.

Further, in the first cycle, the driver D23 associated with the transmitter 130-1 outputs the signal 105-2 as being a logic high between time T11 and time T13 and logic high between time T14 at time T21; the driver D23 associated with the transmitter 130-1 outputs the signal 105-2 as a logic low between time T13 and time T14. Accordingly, the signal 105-1 is set to a 75 percent duty cycle.

In such an instance, for the first cycle in graph 1010, the signal INP is the portion of the signal 105-1 transmitted over the communication path 128-1 and received at the X1 node of the receiver 120-2; the signal INN is the portion of the signal 105-2 transmitted over the communication path 128-2 and received at the X2 node of the receiver 120-2. Thus, as shown in graph 1020 of FIG. 10B, the input of the receiver 120-2 such as between the node X1 and node X2 receives a differential signal S21 equal to INP−INN such as including a respective positive voltage spike just after time T11 and just after time T13 and a negative voltage spike just after time T12 and just after time T14.

In a second cycle between time T21 and time T31, the driver D13 or other suitable entity associated with the transmitter 130-1 outputs the signal 105-1 as being a logic high between time T21 and time T22; the driver D13 outputs the signal 105-1 as a logic low between time T22 and time T31. Accordingly, the signal 105-1 is set to a 25 percent duty cycle.

Further, in the second cycle, the driver D23 outputs the signal 105-2 as being a logic high between time T21 and time T23 and logic high between time T24 at time T31; the driver D23 outputs the signal 105-2 as a logic low between time T23 and time T24. Accordingly, the signal 105-1 is set to a 75 percent duty cycle.

In such an instance, for the second cycle in graph 1010, the portion of the signal 105-1 transmitted over the communication path 128-1 and received at the X1 node of the receiver 120-2 is signal INP; the portion of the signal 105-2 transmitted over the communication path 128-2 and received at the X2 node of the receiver 120-2 is signal INN. Thus, as shown in graph 1020 of FIG. 10B, the differential input of the receiver 120-2 such as between the node X1 and node X2 receives a differential signal S22 equal to INP−INN such as including a respective positive voltage spike just after time T21 and just after time T23 and a respective negative voltage spike just after time T22 and just after time T24.

In a third cycle between time T31 and time T41, the driver D13 of the transmitter 130-1 outputs the signal 105-1 as being a logic high between time T31 and time T32; the driver D13 of the transmitter 130-1 outputs the signal 105-1 as a logic low between time T32 and time T41. Accordingly, the signal 105-1 is set to a 25 percent duty cycle.

Further, in the third cycle, the driver D23 associated with the transmitter 130-1 outputs the signal 105-2 as being a logic high between time T31 and time T33 and between time T34 at time T41; the driver D23 outputs the signal 105-2 as a logic low between time T33 and time T34. Accordingly, the signal 105-1 is set to a 75 percent duty cycle.

In such an instance, for the third cycle in graph 1010, the portion of the signal 105-1 transmitted over the communication path 128-1 and received at the X1 node of the receiver 120-2 is signal INP; the portion of the signal 105-2 transmitted over the communication path 128-2 and received at the X2 node of the receiver 120-2 is signal INN. Thus, as shown in graph 1020 of FIG. 10B, the input of the receiver 120-2 such as between the node X1 and node X2 receives a differential signal S22 equal to INP−INN such as including a respective positive voltage spike just after time T31 and just after time T33 and a respective negative voltage spike just after time T32 and just after time T34.

In this manner, for each of multiple control cycles, the transmitter 130-1 and corresponding drivers can be configured to produce respective signals 105-1 and 105-2 as shown in graph 1010 to communicate a logic one state associated with signal 104-1 over the communication path 128 to the receiver 120-2.

It is again noted that the signal 105-2 may be an inversion of the signal 105-1 but phase shifted by 180 degrees. Accordingly, the wave shape of the signal 105-2 may be substantially similar to the wave shape of the signal 105-1, but inverted and phase shifted 180 degrees. Thus, the transmitter circuit 130-1 can be configured to produce the signals 105-1 and 105-2 such that the second sub-signal (105-2) is phase shifted with respect to the first sub-signal (105-1).

The signal 105-1 can be generated at any suitable frequency. In one example, the transmitter circuit 130-1 transmits the signal 105-1 at or around 500 megahertz.

The signal 105-2 can be generated at any suitable frequency. In one example, the transmitter circuit 130-1 transmits the signal 105-2 at or around 500 megahertz.

Based on the duty cycle control applied to the signal 105-1 and the signal 105-2, the receiver circuit 120-2 receives the differential signal S22 (portion of the transmitted signal 105-1 and transmitted signal 105-2) at a second frequency such as at or around 1 gigahertz, wherein the second frequency is twice a magnitude of the first frequency (such as around 500 megahertz). Thus, the duty cycle control is shown in graph 1010 applied to the signals 105-1 and 105-2 results in signal S22 received at around 1 gigahertz.

As previously discussed, the duty cycle of the signal 105-1 may be around 25 percent. Note that this may vary depending upon the implementation. For example, in further implementations, the duty cycle of the signal 105-1 (first sub-signal) may vary between 15 percent and 35 percent or other suitable percentage.

In similar manner, as previously discussed, the duty cycle of the signal 105-2 may be around 75 percent. Note that this may vary depending upon the implementation. For example, in further implementations, the duty cycle of the signal 105-2 (second sub-signal) may vary between 65 percent and 85 percent or other suitable percentage.

Note further that the appropriate phase control or phase shifting associated with the signal 105-2 with respect to the signal 105-1 in graph 1010 ensures that, for each respective control cycle of multiple control cycles, a respective rising edge (such as at time T21) and a respective falling edge (such as that time T22) of the first sub-signal 105-1 falls in between a respective rising edge (such as at time T14) and a respective falling edge (such as the time T23) of the second sub-signal 105-2.

FIG. 10C is an example diagram illustrating the spectrum of different frequencies and corresponding magnitudes associated with the received differential signal in FIG. 10B.

As shown in graph 1030 and corresponding spectral signal S52 (indicating signal strengths at different frequencies) associated with the signal S22, a magnitude of the received power or voltage associated with the signal S22 (INP-INN) is strongest at the corresponding transmitter frequency (carrier frequency) around 1 gigahertz due to the duty cycle difference between the signal 105-1 and the signal 105-2 as shown in graph 1010. In other words, the duty cycle control as discussed herein is applied to the signal 105-1 in the signal 105-2 results in receiving the signal INP-INN at 1 gigahertz.

It is noted that the difference in duty cycles and controlling edges at different times associated with the drive signals 105-1 and 105-2 as shown in graph 1010 also results in a greater amount of the original signal 105 being transmitted over the communication path 128 as is received at the receiver 120-2. In other words, for each cycle is shown in graph 1020 of FIG. 10B, the receiver 120-2 receives to positive spikes into negative spikes in comparison to graph 920. The stronger signal received at the receiver 120-2 associated with graph 1020 is beneficial because it reduces an amount of errors associated with transmission of respective data over the communication path 128. In other words, the communication system 100 supports a more robust conveyance of respective data over the communication path 128.

Additionally, as shown in FIG. 10C, the frequency of receiving a combination of the respective signal INN and INP over the communication path 128 and corresponding received signal S22 is shifted to a center frequency around 1 gigahertz instead of 500 megahertz (MHz), where the noise floor is lower at 1 gigahertz than at 500 megahertz as shown in FIG. 11.

FIG. 11 is an example diagram illustrating a spectrum of different frequencies and corresponding magnitudes associated with different instances of received differential signals with respect to a noise floor as discussed herein.

Graph 1100 illustrates a spectral analysis of the respective signal S21 and S22 received by the receiver 120-2. As previously discussed, the frequency of receiving signal S22 (based on signal INP and signal INN), which is a portion of the respective signal 105 transmitted/conveyed over the communication path 128, is shifted to a frequency of around 1 Gigahertz (GHz).

The shift of the spectral contributions of the signal S22 to 1 gigahertz (in contrast to 500 megahertz for the signal S21) is beneficial because the noise floor decreases for higher transmit frequencies. More specifically, the noise floor at 500 megahertz is on average approximately 10 microvolts while the noise floor at 1 gigahertz is on average approximately 5 microvolts. Thus, the effective transmission of the differential signal 105 in accordance with the graph 1010 results in a higher signal-to-noise ratio or more robust reception of the transmitted differential signal 105 at the receiver 120-2 because the received signal INP−INN is stronger (larger magnitude) and the noise floor is lower for the drive signals 105-1 and 105-2 as shown in graph 1010.

Thus, as shown in graph 1100 of FIG. 11, the noise floor around 500 megahertz at the receiver 120-2 is greater than a noise floor around 1 gigahertz at the receiver 120-2.

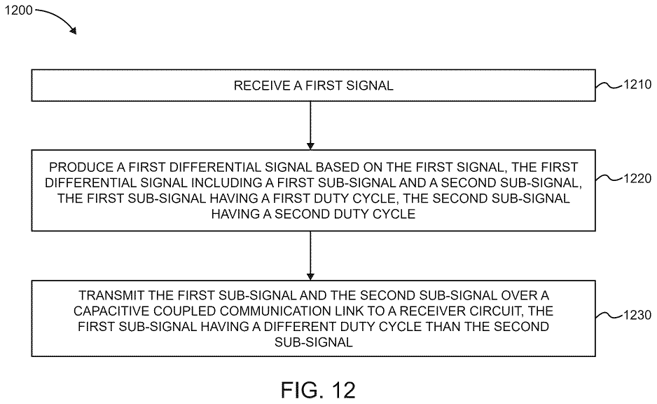

FIG. 12 is an example diagram illustrating a method of controlling a power converter.

In processing operation 1210, the transmitter circuitry 130-1 receives a first signal 104-1.

In processing operation 1220, the transmitter circuitry 130-1 produces a second signal 105 (such as a differential signal) based on the first signal 104-1. The second signal 105 is a differential signal including a first sub-signal 105-1 and a second sub-signal 105-2. The first sub-signal 105-1 is generated to have a first duty cycle; the second sub-signal 105-2 is generated to have a second duty cycle.

In processing operation 1230, the transmitter circuitry 130-1 transmits the first sub-signal 105-1 and the second sub-signal 105-2 over a capacitive coupled communication link (128) to a receiver circuit 120-2. The transmitted first sub-signal 105-1 has a different duty cycle than the transmitted second sub-signal 105-2.

Note again that techniques herein are well suited for use in communication system supporting conveyance of data. However, it should be noted that the concepts in this disclosure are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

It will be understood by those skilled in the art that various changes in form and details may be made therein without departing from the spirit and scope of the present application as defined by the appended claims. Such variations are intended to be covered by the scope of this present application. As such, the foregoing description of the present application is not intended to be limiting. Rather, any limitations to the invention are presented in the following claims.

We claim:

1. An apparatus comprising:
a transmitter circuit operative to:
receive a first signal;
produce a second signal based on the first signal, the second signal being a first differential signal including a first sub-signal and a second sub-signal, the first sub-signal having a first duty cycle, the second sub-signal having a second duty cycle; and
wherein the first sub-signal and the second sub-signal are transmitted over a capacitive coupled communication link to a receiver circuit, the first sub-signal having a different duty cycle than the second sub-signal.

2. The apparatus as in claim 1, wherein the transmitter circuit is operative to control a phase shift of the second sub-signal with respect to the first sub-signal.

3. The apparatus as in claim 2, wherein a wave shape of the second sub-signal is substantially similar to a wave shape of the first sub-signal.

4. The apparatus as in claim 1, wherein the transmitter circuit is operative to transmit both the first sub-signal and the second sub-signal at a first frequency.

5. The apparatus as in claim 4 further comprising:
a receiver operative to receive a second differential signal from the capacitive communication link at a second frequency, wherein the second frequency is received by the receiver at twice a magnitude of the first frequency.

6. At the apparatus as in claim 5, wherein a first noise floor associated with first frequency at the receiver is greater than a second noise floor associated with the second frequency.

7. The apparatus as in claim 1, wherein the capacitive communication link includes a first capacitive coupled communication path and a second capacitive coupled communication path; and
wherein the transmitter circuit is operative to: i) transmit the first sub-signal over the first capacitive coupled communication path, and ii) transmit the second sub-signal over the second capacitive coupled communication path.

8. The apparatus as in claim 1, wherein the first duty cycle of the first sub-signal is between 15 percent and 35 percent; and
wherein the second duty cycle of the second sub-signal is between 65 percent and 85 percent.

9. The apparatus as in claim 1, wherein the transmitter circuit is operative to phase shift the second sub-signal with respect to the first sub-signal such that, for each respective control cycle of multiple control cycles, a respective rising edge and a respective falling edge of the first sub-signal falls in between a respective rising edge and a respective falling edge of the second sub-signal.

10. The apparatus as in claim 1, wherein the transmitter circuit is operative to transmit both the first sub-signal and the second sub-signal at a first frequency;
wherein the capacitive coupled communication link is operative to output a second differential signal at a receiver circuit, the second differential signal representing a portion of the first differential signal conveyed over the capacitive coupled communication link to the receiver circuit; and
wherein the receiver circuit is operative to receive the second differential signal at twice the magnitude of the first frequency.

11. A method comprising:
receiving a first signal;
producing a second signal based on the first signal, the second signal being a first differential signal including a first sub-signal and a second sub-signal, the first sub-signal having a first duty cycle, the second sub-signal having a second duty cycle; and
wherein the first sub-signal and the second sub-signal are transmitted over a capacitive coupled communication link to a receiver circuit, the first sub-signal having a different duty cycle than the second sub-signal.

12. The method as in claim 11, wherein the second sub-signal is phase shifted with respect to the first sub-signal.

13. The method as in claim 12, wherein a wave shape of the second sub-signal is substantially similar to a wave shape of the first sub-signal.

14. The method as in claim 11, wherein the first sub-signal and the second sub-signal are transmitted at a first frequency.

15. The method as in claim 14 further comprising:
via a receiver, receiving a second differential signal from the capacitive coupled communication link at a second frequency, wherein the second frequency is twice a magnitude of the first frequency.

16. The method as in claim 15, wherein a first noise floor of the first frequency at the receiver is greater than a second noise floor a second noise floor of the second frequency at the receiver.

17. The method as in claim 11, wherein the capacitive coupled communication link includes a first capacitive coupled communication path and a second capacitive coupled communication path, the method further comprising:
transmitting the first sub-signal over the first capacitive coupled communication path; and
transmitting the second sub-signal over the second capacitive coupled communication path.

18. The method as in claim 11, wherein the first duty cycle of the first sub-signal is between 15 percent and 35 percent: and
wherein the second duty cycle of the second sub-signal is between 65 percent and 85 percent.

19. The method as in claim 11 further comprising:
phase shifting the second sub-signal with respect to the first sub-signal such that, for each respective control cycle of multiple control cycles, a respective rising edge and a respective falling edge of the first sub-signal falls in between a respective rising edge and a respective falling edge of the second sub-signal.

20. The method as in claim 11 further comprising:
transmitting both the first sub-signal and the second sub-signal at a first frequency;
wherein the capacitive coupled communication link is operative to output a second differential signal to the receiver circuit, the second differential signal representing a portion of the first differential signal conveyed over the capacitive coupled communication link to the receiver circuit; and
wherein the receiver circuit is operative to receive the second differential signal at twice a magnitude of the first frequency.
